(19) United States
(12) Patent Application Publication
(10) Pub. No.: US 2013/0262896 A1
(43) Pub. Date: Oct. 3, 2013

(54) PROCESSOR AND ELECTRONIC DEVICE

(71) Applicant: SEMICONDUCTOR ENERGY LABORATORY CO., LTD., Atsugi-shi (JP)

(72) Inventor: Seiichi Yoneda, Atsugi (JP)

(73) Assignee: Semiconductor Energy Laboratory Co., Ltd., Atsugi-shi (JP)

(21) Appl. No.: 13/849,592

(22) Filed: Mar. 25, 2013

(30) Foreign Application Priority Data
Mar. 29, 2012 (JP) 2012-075775

(51) Int. Cl. G06F 1/32

(52) U.S. Cl. CPC G06F 1/324
USPC 713/322

(57) ABSTRACT

Power consumption is reduced. A processor includes an instruction register unit in which data of a plurality of instructions is fetched; an instruction decoder unit in which each of the plurality of instructions is translated; a logic unit including a functional circuit which is supplied with a clock signal and a power source voltage, supplied with a data signal including the translated data of the instructions, and operates in accordance with the supplied data of the instructions; a data analysis unit in which the translated data is analyzed so as to calculate a non-operating period of the functional circuit, and a control signal is generated; and a control unit which controls the supply of the clock signal or both the clock signal and the power source voltage to the functional circuit in accordance with the control signal.

### TECHNICAL FIELD

The present invention relates to a processor. The present invention also relates to an electronic device including the processor.

### BACKGROUND ART

In recent years, techniques for reducing the power consumption of processors have been developed.

The reduction in power consumption is realized by clock gating or power gating, for example.

The clock gating is a technique for controlling the supply of a clock signal to a circuit so as to stop the supply of the clock signal to, for example, a circuit which is not in use.

The power gating is a technique for controlling the supply of a power source voltage to a circuit so as to stop the supply of the power source voltage to, for example, a circuit which is not in use.

The aforementioned clock gating and power gating are performed in accordance with, for example, instruction data input to a processor (see Patent Document 1, for example).

### REFERENCE

### Patent Document

[Patent Document 1] Japanese Published Patent Application No. 2005-38186

### DISCLOSURE OF INVENTION

In conventional clock gating or power gating, power is consumed in stopping or restarting the supply of a clock signal or a power source voltage. Further, in power gating, data stored in a flip-flop or the like is saved before the supply of a power source voltage to a processor is stopped. In order to rewrite the data to the flip-flop after the power supply is restarted, more power is needed.

Therefore, in an instruction execution period for example, when clock gating or power gating is carried out in the case where the supply of a clock signal and a power source voltage is stopped for a short period of time, power consumption rather increases in some cases, which has not led to a sufficient reduction in power consumption.

An object of one embodiment of the present invention is to reduce power consumption.

In one embodiment of the present invention, data of sequential instructions is translated (decoded) at a time and the translated data of instructions is analyzed so as to calculate the length of a non-operating period of a functional circuit when two or more instructions among the plurality of instructions are sequentially executed. In accordance with the analysis result, whether clock gating is performed or both clock gating and power gating are performed on the functional circuit is selected.

In the above method, the length of the non-operating period is calculated for the data of the plurality of instructions. Accordingly, clock gating or both clock gating and power gating can be performed only in the non-operating period during which the amount of power saved by clock gating or power gating is larger than the amount of power consumed in performing clock gating or power gating. Thus, a reduction in power consumption is achieved.

One embodiment of the present invention is a processor including an instruction register unit in which data of a plurality of instructions is fetched; an instruction decoder unit in which each of the plurality of instructions fetched in the instruction register unit is translated; a logic unit including a functional circuit which is supplied with a clock signal and a power source voltage, supplied with a data signal including the translated data of the instructions, and operates in accordance with the supplied data of the instructions; a data analysis unit in which the translated data of two or more instructions among the plurality of instructions is analyzed so as to calculate a non-operating period of the functional circuit when the two or more instructions are sequentially executed, and a control signal is generated so as to stop supply of the clock signal or both the clock signal and the power source voltage to the functional circuit in accordance with the length of the non-operating period; and a control unit which controls the supply of the clock signal or both the clock signal and the power source voltage to the functional circuit in accordance with the control signal.

In one embodiment of the present invention, the non-operating period is calculated from the data of sequential instructions; therefore, clock gating or both clock gating and power gating can be selected to be performed only when a reduction in power consumption is achieved, resulting in a reduction in power consumption.

### BRIEF DESCRIPTION OF DRAWINGS

In the accompanying drawings:

FIG. 1 shows an example of a configuration of a processor;

FIG. 2 shows an example of a configuration of a processor;

FIG. 3 shows an example of a configuration of an instruction register unit and an instruction decoder unit;

FIG. 4 shows an example of a configuration of a data analysis unit;

FIG. 5 shows an example of a configuration of a control unit;

FIG. 6 is a flowchart showing an example of a method for driving a processor;

FIG. 7 is a flowchart showing an example of a method for driving a processor;

FIG. 8 is a diagram showing an example of a method for driving a processor;

FIG. 9 is a flowchart showing an example of a method for driving a processor;

FIG. 10 is a flowchart showing an example of a method for driving a processor;

FIG. 11 is a flowchart showing an example of a method for driving a processor;

FIGS. 12A and 12B show an example of a configuration of a register;

FIG. 13 is an Arrhenius plot showing the off-state current of a transistor;

FIG. 14 is a timing chart showing an example of a method for driving a register;

FIGS. 15A and 15B are schematic cross-sectional views each showing an example of a structure of a transistor;

FIGS. 16A to 16F each show an example of an electronic device; and

FIG. 17 shows a specific example of a data analysis unit.

### BEST MODE FOR CARRYING OUT THE INVENTION

Embodiments of the present invention will be described below. Note that it will be readily appreciated by those skilled in the art that details of the embodiments can be modified without departing from the spirit and scope of the present invention. Thus, the present invention should not be limited to, for example, the description of the following embodiments.

Note that the contents of different embodiments can be combined with one another as appropriate. In addition, the contents of the embodiments can be replaced with each other as appropriate.

Further, the ordinal numbers such as “first” and “second” are used to avoid confusion between components and do not limit the number of each component.

### Embodiment 1

In this embodiment, an example of a processor will be described.

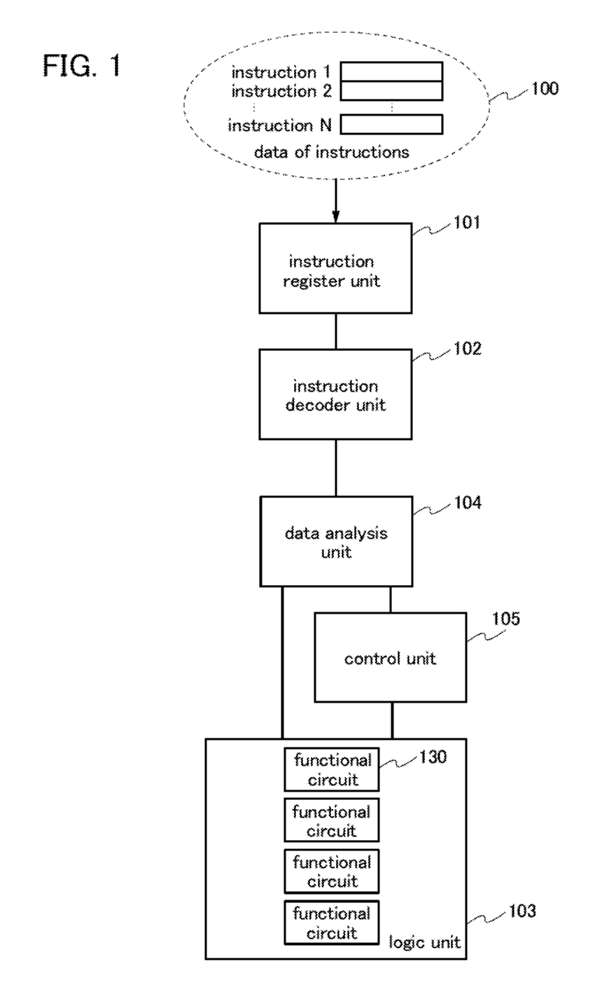

FIG. 1 shows an example of a configuration of the processor of this embodiment.

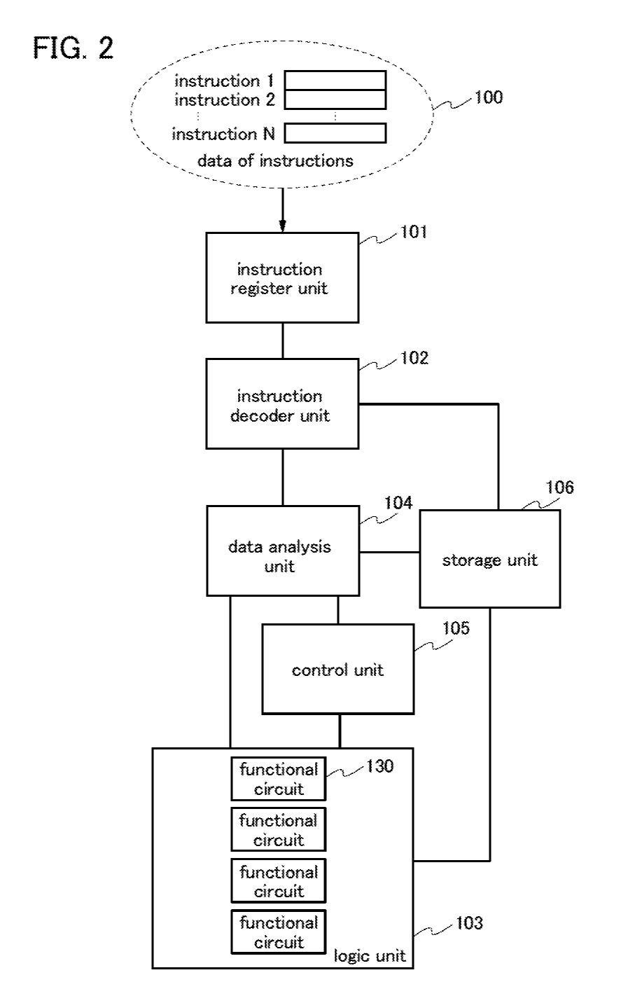

The processor shown in FIG. 1 includes an instruction register unit 101, an instruction decoder unit 102, a logic unit 103, a data analysis unit 104, and a control unit 105. Note that as shown in FIG. 2, a storage unit 106 may be provided to read or write data from or to each of the instruction decoder unit 102, the logic unit 103, and the data analysis unit 104. The storage unit 106 is provided with a plurality of registers including a register file, an accumulator, a program counter, a flag register, and the like.

Data 100 of sequential instructions is fetched in the instruction register unit 101. The instruction register unit 101 has a function of storing data of instructions to be translated. The instruction decoder unit 102 has a function of decoding each data of instructions which has been fetched in the instruction register unit 101. The data 100 of instructions is input, for example, from a memory through an interface.

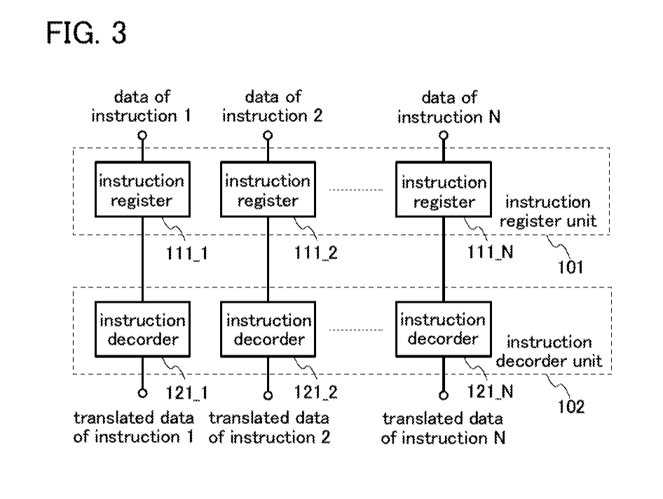

For example, in the instruction register unit 101, instruction registers 111 (instruction registers 111_1 to 111_N) are provided corresponding to respective data of instructions (data of an instruction 1 to data of an instruction N) as shown in FIG. 3. Further, in the instruction decoder unit 102, instruction decoders 121 (instruction decoders 121_1 to 121_N) are provided corresponding to the respective data of instructions (data of the instruction 1 to data of the instruction N).

The logic unit 103 shown in FIG. 1 and FIG. 2 includes a functional circuit 130. The functional circuit 130 is supplied with a clock signal CLK and a power source voltage PWR. The functional circuit 130 is also supplied with a data signal including the data of a plurality of instructions which has been translated in the instruction decoder unit 102. The functional circuit 130 operates in accordance with the supplied data of instructions. Note that the logic unit 103 may include a plurality of the functional circuits 130 as shown in FIG. 1 and FIG. 2. In addition, a signal other than the data signal including the data of instructions and the clock signal CLK may be input to the functional circuit 130.

A circuit whose operation is controlled by the clock signal CLK and started with the power source voltage PWR can be used as the functional circuit 130. The functional circuit 130 is configured by using, for example, one or more of a NOT circuit, an OR circuit, an AND circuit, a NOR circuit, and a NAND circuit. For example, a register or a flip-flop may be used to configure the functional circuit 130. Further, an addition circuit or a subtraction circuit obtained by combining a plurality of logic circuits may be used as the functional circuit 130.

The data analysis unit 104 analyzes the data of a plurality of instructions which has been translated in the instruction decoder unit 102, thereby calculating a period (also referred to as a non-operating period) during which the functional circuit 130 does not need to operate when a plurality of instructions are executed sequentially. Furthermore, the data analysis unit 104 determines, in accordance with the length of the non-operating period, a period during which the supply of the clock signal CLK or both the clock signal CLK and the power source voltage PWR to the functional circuit 130 is stopped.

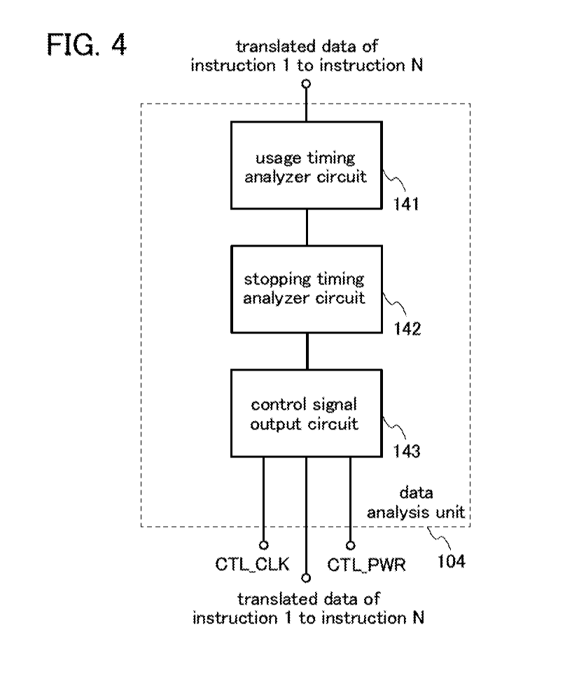

The data analysis unit 104 includes, for example, a usage timing analyzer circuit 141, a stopping timing analyzer circuit 142, and a control signal output circuit 143 as shown in FIG. 4.

The usage timing analyzer circuit 141 has a function of analyzing a data signal including translated data of a plurality of instructions (translated data of the instruction 1 to the instruction N) so as to calculate the non-operating period of the functional circuit 130 when the plurality of instructions are executed sequentially.

The stopping timing analyzer circuit 142 has a function of determining, in accordance with the data of the non-operating period calculated by the usage timing analyzer circuit 141, the timing and length of a period during which the supply of the clock signal CLK or both the clock signal CLK and the power source voltage PWR to the functional circuit 130 is stopped.

For example, in the stopping timing analyzer circuit 142, numerical data indicating the non-operating period calculated by the usage timing analyzer circuit 141 is compared with reference numerical data indicating a period T1 and a period T2. The period T2 is longer than the period T1.

The control signal output circuit 143 has a function of generating and outputting, based on the comparison results of the stopping timing analyzer circuit 142, a control signal CTL_CLK for controlling the supply of the clock signal CLK to the functional circuit 130, and a control signal CTL_PWR for controlling the supply of the power source voltage PWR to the functional circuit 130.

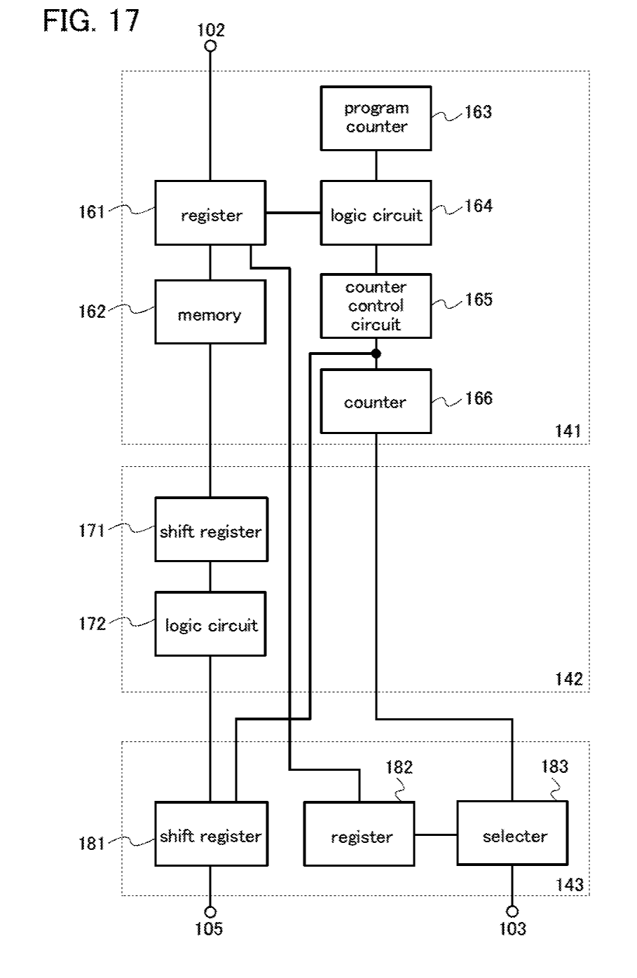

FIG. 17 shows a more specific example of the data analysis unit 104.

The usage timing analyzer circuit 141 shown in FIG. 17 includes a register 161, a memory 162, a program counter 163, a logic circuit 164, a counter control circuit 165, and a counter 166.

The register 161 has a function of storing data of a plurality of instructions input from the instruction decoder unit 102.

The memory 162 stores data (e.g., binary digital data) indicating whether the functional circuit 130 operates or not when the instructions are executed based on the input data of the instructions. The memory 162 has a function of outputting data indicating whether the functional circuit 130 operates or not in accordance with the data of the instructions input from the register 161. The memory 162 includes, for example, an associative memory. Note that the logic circuit 164 may be used to control the output of the data from the memory 162.

The program counter 163 stores at least address data with the smallest value among address data corresponding to the data of a plurality of instructions which is fetched in the instruction register unit 101. For example, in the case where data of sequential instructions is fetched in the instruction register unit 101, address data of the first instruction to be executed is stored in the program counter 163. If the address data of the first instruction to be executed is stored, it is possible to determine addresses of the other sequential instructions.

The logic circuit 164 has a function of searching for data of a plurality of instructions stored in the register 161 with reference to the address data stored in the program counter 163, thereby determining addresses corresponding to the translated data of instructions. Accordingly, in the case where the translated instructions include, for example, a conditional branch instruction, it is possible to determine whether the translated data of instructions also includes data corresponding to an address to be jumped to.

The counter control circuit 165 has a function of controlling the counting of the counter 166 in accordance with the data of instructions determined by the logic circuit 164. For example, the counter control circuit 165 increments the counter 166 in the order of execution of the instructions stored in the register 161. Further, in the case where the data of the instructions includes a conditional branch instruction and data to be jumped to, for example, the counter control circuit 165 may increment the counter 166 to a value corresponding to the address data of the conditional branch instruction with reference to the result of the conditional branch in the functional circuit 130, and then, the count value may be changed to a value corresponding to the address to be jumped to in the conditional branch instruction.

A clock signal is input from the counter control circuit 165 to the counter 166, and the counter 166 is incremented in accordance with the clock signal. Note that when a count value of the counter 166 is judged by a logic circuit to be higher than or equal to a reference value, an output node of the counter 166 may be brought into a floating state by a switch, and further, another value (e.g., a value corresponding to the address to be jumped to in the conditional branch instruction) may be written to the output node by another switch.

The stopping timing analyzer circuit 142 shown in FIG. 17 includes a shift register 171 and a logic circuit 172.

The shift register 171 is configured by, for example, a serial-in/parallel-out shift register. Data indicating whether the functional circuit 130 operates or not is sequentially input from the memory 162 to the shift register 171 per one clock pulse. The clock pulse corresponds to one period. A plurality of the shift registers 171 may be provided separately for generating the control signal CTL_CLK which controls the supply of the clock signal CLK, and for generating the control signal CTL_PWR which controls the supply of the power source voltage PWR. In that case, data indicating whether the functional circuit 130 operates or not is sequentially input from the memory 162 in the usage timing analyzer circuit 141 to each of the shift registers 171 per one clock pulse.

In the shift register 171, the data indicating whether the functional circuit 130 operates or not is shifted through flip-flops in accordance with the clock pulse, and the data is sequentially output as any one of a plurality of data signals output from the plurality of flip-flops.

With use of the plurality of data signals input from the shift register 171, the logic circuit 172 performs logic operation equivalent to comparison operation, and outputs a plurality of data signals each having a potential determined by the result of the logic operation. At this time, the number of output data signals is preferably equal to the number of the data signals input from the shift register 171.

For example, in the case where the control signal CTL_CLK is generated in the control signal output circuit 143, when the number of pieces of data, which are output as data signals from the sequential flip-flops in the shift register 171 and indicate the non-operation of the functional circuit 130, exceeds a reference value (corresponding to the period T1), the logic circuit 172 outputs, in accordance with the plurality of data signals output from the sequential flip-flops, a plurality of low-level data signals as data indicating stopping of the supply of the clock signal CLK; in the other cases, the logic circuit 172 outputs high-level data signals. In the case of generating the control signal CTL_PWR, when the aforementioned number of pieces of data exceeds a reference value (corresponding to the period T2), the logic circuit 172 outputs, in accordance with the data signals output from the sequential flip-flops, a plurality of low-level data signals as data indicating stopping of the supply of the power source voltage PWR; in the other cases, the logic circuit 172 outputs high-level data signals. Thus, data of a plurality of data signals output from the logic circuit 172 each indicates stopping of the supply of the clock signal CLK or the power source voltage PWR which corresponds to each instruction.

The control signal output circuit 143 shown in FIG. 17 includes a shift register 181, a register 182, and a selector 183.

The shift register 181 is configured by, for example, a parallel-in/serial-out shift register. A plurality of the shift registers 181 may be provided for generating the control signal CTL_CLK and for generating the control signal CTL_PWR, for example. In that case, data of a plurality of data signals output from the logic circuit 172 is input to each of the shift registers 181.

A data signal is input from the logic circuit 172 to each corresponding flip-flop in the shift register 181. In the shift register 181, data indicating stopping of the supply of the clock signal CLK or the power source voltage PWR in the execution period of each instruction is shifted through flip-flops in accordance with a clock pulse. Thus, for example, data output from the flip-flop in the last stage is sequentially changed into data indicating stopping of the supply of the clock signal CLK or the power source voltage PWR in accordance with a clock pulse, the data corresponding to a plurality of instructions. At this time, the shift register 181 outputs the data from the flip-flop in the last stage as the control signal CTL_CLK or the control signal CTL_PWR. Note that the clock signal input to the shift register 181 is preferably a clock signal output from the counter control circuit 165, for example. As a result, it is possible to synchronize the timing of the operation of the functional circuit 130 based on the instructions with the timing of stopping the clock signal CLK and the power source voltage PWR.

Data of a plurality of instructions output from the register 161 is stored in the register 182.

The selector 183 has a function of controlling which of the data of the instructions stored in the register 182 is output in accordance with the count value of the counter 166. For example, when the count value of the counter 166 is “100”, data of an instruction with address “100” stored in the register 182 can be selected and output by the selector 183.

That is a specific example of the data analysis unit 104.

The control unit 105 shown in FIG. 1 and FIG. 2 has a function of controlling the supply of the clock signal CLK or both the clock signal CLK and the power source voltage PWR to the functional circuit 130 in accordance with the analysis results of the data analysis unit 104.

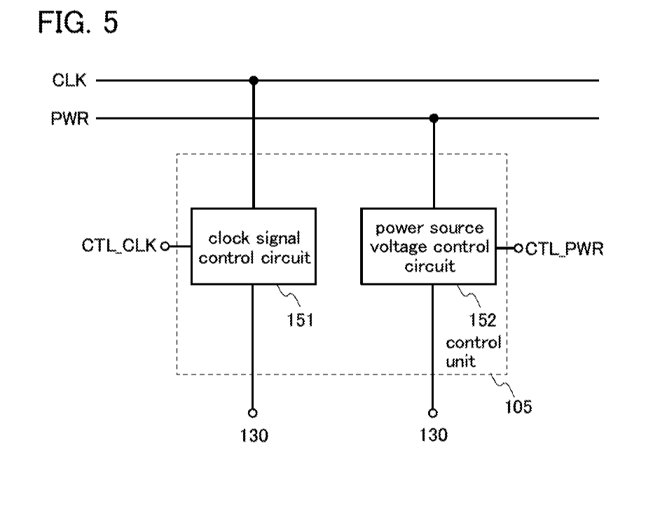

The control unit 105 includes, for example, a clock signal control circuit 151 and a power source voltage control circuit 152 as shown in FIG. 5.

The clock signal control circuit 151 has a function of controlling the supply of the clock signal CLK to the functional circuit 130 in accordance with the control signal CTL_CLK. For example, a switch (e.g., a clock gate) is provided and turned on with the control signal CTL_CLK, whereby the clock signal CLK can be supplied to the functional circuit 130.

The power source voltage control circuit 152 has a function of controlling the supply of the power source voltage PWR to the functional circuit 130 in accordance with the control signal CTL_PWR. For example, a switch (e.g., a power gate) is provided and turned on with the control signal CTL_PWR, whereby the power source voltage PWR can be supplied to the functional circuit 130.

That is the description of an example of the configuration of the processor shown in FIG. 1 and FIG. 2.

Next, an example of a method for driving the processor of this embodiment will be described.

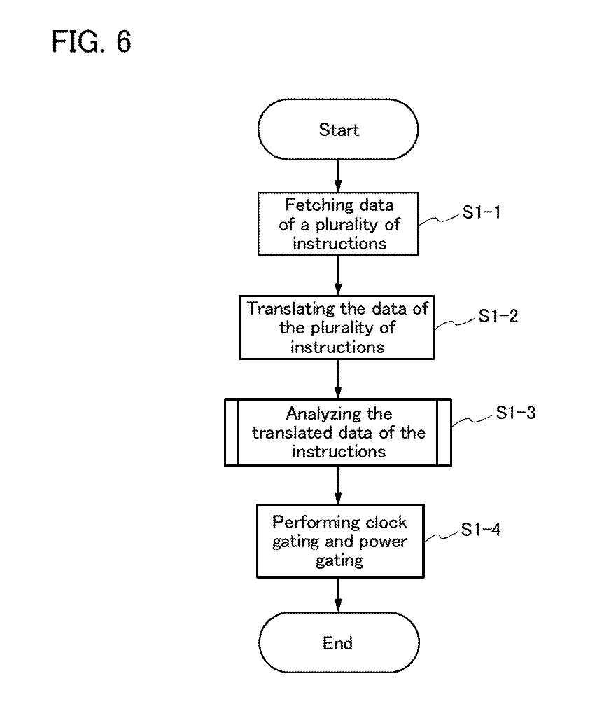

FIG. 6 is a flowchart showing an example of the method for driving the processor shown in FIG. 1.

In the example of the method for driving the processor shown in FIG. 1, data of a plurality of instructions is fetched in step S1-1.

At this time, the data of the plurality of instructions is fetched in the instruction register unit 101.

Then, the data of the plurality of instructions that has been fetched in the instruction register unit 101 is translated in step S1-2.

At this time, each of the instructions that have been fetched in the instruction register unit 101 is translated in the instruction decoder unit 102.

The translated data of the instructions is input to the data analysis unit 104.

Next, the translated data of the instructions is analyzed in step S1-3.

At this time, in the data analysis unit 104, the translated data of the instructions is analyzed to calculate a non-operating period T0 of the functional circuit 130 when the instructions are sequentially executed. Then, in accordance with the length of the non-operating period T0, a control signal is generated to stop the supply of the clock signal CLK or both the clock signal CLK and the power source voltage PWR to the functional circuit 130.

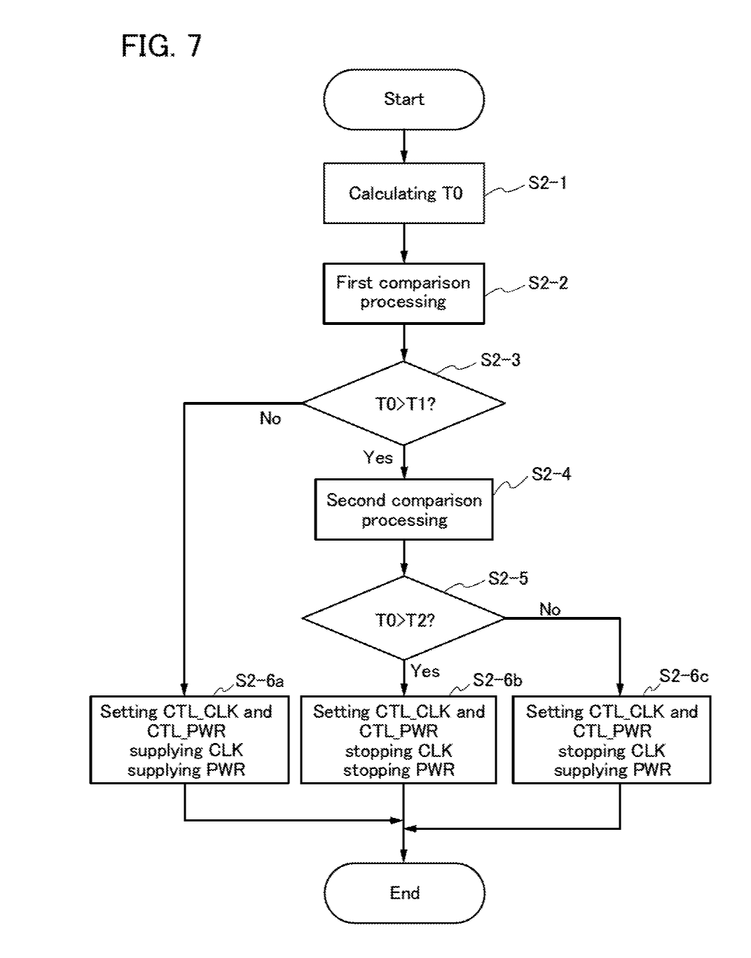

Here, a specific example of the data analysis in step S1-3 will be described with reference to a flowchart of FIG. 7. The description is made on the assumption that the data analysis unit 104 has the configuration shown in FIG. 4, though the configuration of the data analysis unit 104 is not limited to this.

First, the non-operating period T0 is calculated in step S2-1.

At this time, the data of the plurality of instructions is analyzed by the usage timing analyzer circuit 141, whereby the non-operating period T0 is calculated.

For example, in the case of the configuration shown in FIG. 17, in the usage timing analyzer circuit 141, the content of data of instructions stored in the register 161 is determined by the logic circuit 164 with use of address data stored in the program counter 163. Note that corresponding data of a plurality of instructions may be input from an external memory to the instruction register unit 101 in accordance with the address data stored in the program counter 163.

Further, data indicating whether the functional circuit 130 operates or not, which corresponds to the data of instructions input from the register 161, is output from the memory 162 by the logic circuit 164.

Next, first comparison processing is performed in step S2-2.

At this time, the length of the non-operating period T0 of the functional circuit 130, which has been calculated by the usage timing analyzer circuit 141, is quantified by the stopping timing analyzer circuit 142, and numerical data indicating the non-operating period T0 is compared with numerical data indicating the period T1. The period T1 is a period during which the clock signal CLK is stopped, which is needed to offset the power consumption overhead when the supply of the clock signal CLK is stopped. For example, the period T1 can be determined by the design specifications of the processor.

Then, whether the non-operating period T0 is longer than the period T1 is determined in step S2-3 based on the result of the first comparison processing.

In the case where the non-operating period T0 is shorter than or equal to the period T1, the supply of the clock signal CLK and the power source voltage PWR to the functional circuit 130 is not stopped. Accordingly, in step S2-6a, the control signal CTL_CLK and the control signal CTL_PWR are set to values allowing the clock signal CLK and the power source voltage PWR to keep being supplied to the functional circuit 130, and these control signals are output from the control signal output circuit 143.

In the case where the non-operating period T0 is longer than the period T1, second comparison processing is performed in step S2-4.

At this time, the numerical data indicating the non-operating period T0 is compared with the numerical data indicating the period T2 by the stopping timing analyzer circuit 142. The period T2 is a period during which the clock signal CLK and the power source voltage PWR are stopped, which is needed to offset the power consumption overhead when the supply of the clock signal CLK and the power source voltage PWR is stopped. For example, the period T2 can be determined by the design specifications of the processor.

Then, whether the non-operating period T0 is longer than the period T2 is determined in step S2-5 based on the result of the second comparison processing.

In the case where the non-operating period T0 is longer than the period T2, the supply of the clock signal CLK and the power source voltage PWR is stopped. Accordingly, in step S2-6b, the control signal CTL_CLK and the control signal CTL_PWR are set to values for stopping the supply the clock signal CLK and the power source voltage PWR, and these control signals are output from the control signal output circuit 143.

In the case where the non-operating period T0 is shorter than or equal to the period T2, the supply of the power source voltage PWR to the functional circuit is not stopped though the supply of the clock signal CLK to the functional circuit 130 can be stopped. Accordingly, in step S2-6c, the control signal CTL_CLK and the control signal CTL_PWR are set to values which allow the supply of the clock signal CLK to the functional circuit 130 to be stopped and the supply of the power source voltage PWR to keep being supplied to the functional circuit 130, and these control signals are output from the control signal output circuit 143.

For example, in the case of the configuration shown in FIG. 17, in the stopping timing analyzer circuit 142, a plurality of data signals input from the usage timing analyzer circuit 141 (data signals indicating whether the functional circuit 130 operates or not) are shifted through the shift register 171, and are output from the respective flip-flops in the shift register 171. Further, in the stopping timing analyzer circuit 142, the plurality of data signals output from the flip-flops are subjected to arithmetic processing in the logic circuit 172, and whether the data signals output from the logic circuit 172 indicate stopping of the supply of the clock signal CLK or the power source voltage PWR (e.g., whether low-level data signals are output) is determined by the result of the arithmetic processing. Then, the control signal output circuit 143 outputs the control signal CTL_CLK or the control signal CTL_PWR as data output from the flip-flop in the last stage in the shift register 181 to which the data signals are input from the logic circuit 172.

That is the description of a specific example of the data analysis in step S1-3.

Next, in step S1-4 shown in FIG. 6, the supply of a clock signal or both a clock signal and a power source voltage to the functional circuit 130 is controlled in accordance with the control signal generated in the data analysis unit 104, whereby clock gating and power gating are carried out.

At this time, the supply of the clock signal CLK is stopped for the functional circuit 130 whose non-operating period T0 is determined to be longer than the period T1, and the supply of the clock signal CLK and the power source voltage PWR is stopped for the functional circuit 130 whose non-operating period T0 is determined to be longer than the period T2.

The functional circuit 130 supplied with the clock signal CLK and the power source voltage PWR operates in accordance with input data of instructions. The data of instructions is input to the functional circuit 130 through the data analysis unit 104; however, one embodiment of the present invention is not limited to this, and data of instructions translated in the instruction decoder unit 102 may be directly input to the logic unit 103.

If there is another data of instructions, the above operation is carried out again.

For example, in the case of the configuration shown in FIG. 17, in the usage timing analyzer circuit 141, the counter control circuit 165 increments the counter 166 in accordance with the data of a plurality of instructions determined by the logic circuit 164. On the basis of the count value, the data of instructions stored in the register 182 is output from the control signal output circuit 143 to the functional circuit 130 through the selector 183. When the shift register 181 and the counter 166 are controlled with use of the same clock signal, the functional circuit 130 can operate while the timing at which the data of instructions is output to the functional circuit 130 through the selector 183 is synchronized with the timing at which the clock signal CLK and the power source voltage PWR are supplied.

That is the description of an example of the method for driving the processor shown in FIG. 1.

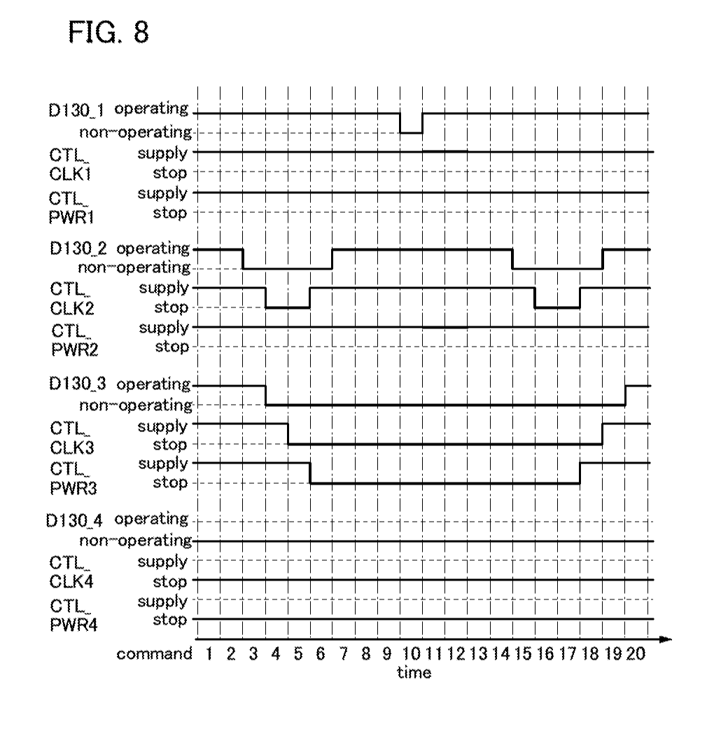

Further, another example of the method for driving the processor will be described with reference to FIG. 8; in this example, the logic unit 103 includes functional circuits 130_1 to 130_4, and data of instructions 1 to 20 is analyzed at a time as data of a plurality of instructions. FIG. 8 is a schematic view showing an example of data analysis. The horizontal axis represents time, and the instructions 1 to 20 are sequentially executed at each time. It is considered that the instructions 1 to 20 have the same execution period, the period T1 is equal to the length of 1 instruction, and the period T2 is equal to the lengths of 11 instructions. For convenience, control signals CTL_CLK supplied to the functional circuits 130_1 to 130_4 are denoted as control signals CTL_CLK1 to CTL_CLK4, respectively, and control signals CTL_PWR supplied to the functional circuits 130_1 to 130_4 are denoted as control signals CTL_PWR1 to CTL_PWR4, respectively. Further, the control signals CTL_CLK1 to CTL_CLK4 and the control signals CTL_PWR1 to CTL_PWR4 are each a digital signal.

Non-operating periods T0 of the functional circuits 130_1 to 130_4, which have been analyzed in step S2-1, can be denoted as data D130_1 to data D130_4 in FIG. 8.

In that case, the functional circuit 130_1 does not operate in a period during which the instruction 10 is executed (non-operating period T0). The functional circuit 130_2 does not operate in a period during which the instructions 3 to 6 are executed (non-operating period T0a), and in a period during which the instructions 15 to 18 are executed (non-operating period T0b). The functional circuit 130_3 does not operate in a period during which the instructions 4 to 19 are executed (non-operating period T0). The functional circuit 130_4 does not operate in a period during which the instructions 1 to 20 are executed (non-operating period T0). In the case where a plurality of instructions are sequentially executed in the single functional circuit 130, a plurality of non-operating periods may exist in such a manner.

Furthermore, based on the non-operating period T0 analyzed above, the first comparison processing in step S2-2 and the second comparison processing in step S2-4 are performed; as a result, in the functional circuit 130_1, the length of the non-operating period T0 in the instruction 10 is shorter than or equal to the period T1. Accordingly, in a period during which the instructions 1 to 20 are executed, each of the control signals CTL_CLK1 and CTL_PWR1 is set to high level, whereby both the clock signal CLK and the power source voltage PWR are supplied to the functional circuit 130_1.

In the functional circuit 130_2, the non-operating period T0a in the instructions 3 to 6 is longer than the period T1 and shorter than or equal to the period T2. Accordingly, in a period during which the instructions 4 and 5 are executed, the control signal CTL_CLK2 is set to low level so that the supply of the clock signal CLK to the functional circuit 130_2 is stopped, and the control signal CTL_PWR2 is set to high level so that the power source voltage PWR is supplied to the functional circuit 130_2. Further, the non-operating period T0b in the instructions 15 to 18 is longer than the period T1 and shorter than or equal to the period T2. Accordingly, in a period during which the instructions 16 and 17 are executed, the control signal CTL_CLK2 is set to low level so that the supply of the clock signal CLK to the functional circuit 130_2 is stopped, and the control signal CTL_PWR2 is set to high level so that the power source voltage PWR is supplied to the functional circuit 130_2. Although the control signals CTL_CLK and CTL_PWR are controlled for each instruction in FIG. 8, one embodiment of the present invention is not limited to this and the pulses of the control signals CTL_CLK and CTL_PWR may be changed in a part of an instruction period. Also in FIG. 8, in the case where the supply of the clock signal CLK and the power source voltage PWR is stopped, the period during which the control signals CTL_CLK and CTL_PWR are at low level is shorter than the non-operating period T0 in order to suppress occurrence of failure in operation. However, one embodiment of the present invention is not limited to this, and the period during which the control signals CTL_CLK and CTL_PWR are at low level may be equal to the non-operating period T0.

In the functional circuit 130_3, the non-operating period T0 in the instructions 4 to 19 is longer than the period T2. Accordingly, the control signal CTL_CLK3 is set to low level in a period during which the instructions 5 to 18 are executed, and the control signal CTL_PWR3 is set to low level in a period during which the instructions 6 to 17 are executed, whereby the supply of the clock signal CLK and the power source voltage PWR to the functional circuit 130_3 is stopped.

In the functional circuit 130_4, the non-operating period T0 in the instructions 1 to 20 is longer than the period T2. Accordingly, the control signal CTL_CLK4 and the control signal CTL_PWR4 are set to low level in a period during which the instructions 1 to 20 are executed, whereby the supply of the clock signal CLK and the power source voltage PWR to the functional circuit 130_4 is stopped.

As described above, in the processor shown in FIG. 1, data of a plurality of instructions is analyzed and the values of the control signals CTL_CLK and CTL_PWR are determined based on the analysis results; thus, a period during which the supply of the clock signal CLK is stopped and a period during which the supply of the power source voltage PWR is stopped can be determined for each of the functional circuits 130.

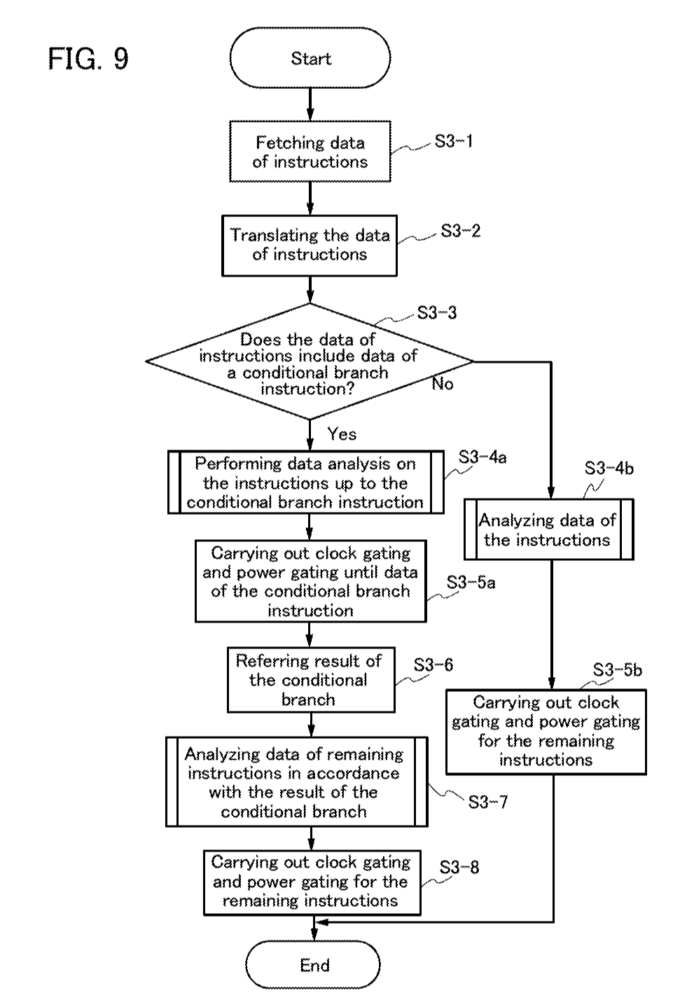

Another example of the method for driving the processor of this embodiment will be described with reference to a flowchart of FIG. 9. Note that for the same part as that in the aforementioned method for driving the processor, the aforementioned method for driving the processor is referred to as appropriate. Here, an example of the method for driving the processor shown in FIG. 2 will be described as an example.

In the example of the method for driving the processor shown in FIG. 2, data of a plurality of instructions is fetched in step S3-1, and the data of instructions fetched in the instruction register unit 101 is translated in step S3-2.

The translated data of instructions is input to the data analysis unit 104.

Further, in step S3-3, it is determined whether the data of instructions includes data of a conditional branch instruction. Whether the data includes a conditional branch instruction can be determined by a high-order bit of the data, for example.

For example, in the case of the configuration shown in FIG. 17, in the usage timing analyzer circuit 141, the content of data of instructions stored in the register 161 is determined by the logic circuit 164 with use of address data stored in the program counter 163, whereby the data of the conditional branch instruction is determined.

In the case where the data of instructions includes the data of the conditional branch instruction, in step S3-4a, data analysis is performed on the instructions up to the conditional branch instruction among the plurality of translated instructions.

At this time, in the data analysis unit 104, the translated data of the instructions is analyzed to calculate the non-operating period T0 of the functional circuit 130 when the instructions up to the conditional branch instruction among the plurality of instructions are sequentially executed. Then, in accordance with the length of the non-operating period T0, the control signals CTL_CLK and CTL_PWR are generated to determine to stop the supply of the clock signal CLK or both the clock signal CLK and the power source voltage PWR to the functional circuit 130. For a specific example of the data analysis, the example described with reference to the flowchart of FIG. 7 can be referred to.

Further, in step S3-5a, the supply of the clock signal CLK or both the clock signal CLK and the power source voltage PWR to the functional circuit 130 is controlled in accordance with the control signals (CTL_CLK and CTL_PWR) generated in the data analysis unit 104, whereby clock gating and power gating are carried out. In the case where the data of the instructions does not include the data of the conditional branch instruction, the data of the instructions is analyzed in step S3-4b. Then, in step S3-5b, the supply of the clock signal CLK or both the clock signal CLK and the power source voltage PWR to the functional circuit 130 is controlled in accordance with the control signals generated in the data analysis unit 104, whereby clock gating and power gating are carried out.

In addition, in the case where the data of the instructions includes the data of the conditional branch instruction, the result of the conditional branch is referred to in step S3-6. For example, the result of the conditional branch can be referred to in the data analysis unit 104 or the like by writing flag data indicating the result of the conditional branch to the storage unit 106 shown in FIG. 2.

Next, in step S3-7, data of the remaining instructions is analyzed in accordance with the result of the conditional branch. For example, the flag data stored in a flag register or the like in the storage unit 106 is monitored by the data analysis unit 104, and if instructions remain after the conditional branch, data of the remaining instructions can be analyzed.

Further, in step S3-8, the supply of the clock signal CLK or both the clock signal CLK and the power source voltage PWR to the functional circuit 130 is controlled in accordance with the control signals (CTL_CLK and CTL_PWR) generated in the data analysis unit 104, whereby clock gating and power gating are carried out for the remaining instructions.

The functional circuit 130 supplied with the clock signal CLK and the power source voltage PWR operates in accordance with input data of instructions. The data of instructions is input to the functional circuit 130 through the data analysis unit 104; however, one embodiment of the present invention is not limited to this, and data of instructions translated in the instruction decoder unit 102 may be directly input to the logic unit 103.

If there is another data of instructions, the above operation is carried out again.

That is the description of another example of the method for driving the processor of this embodiment.

As described above, in another example of the method for driving the processor of this embodiment, processing is changed depending on whether there is a conditional branch instruction or not, which avoids unnecessary analysis of data of instructions and thus increases operation speed.

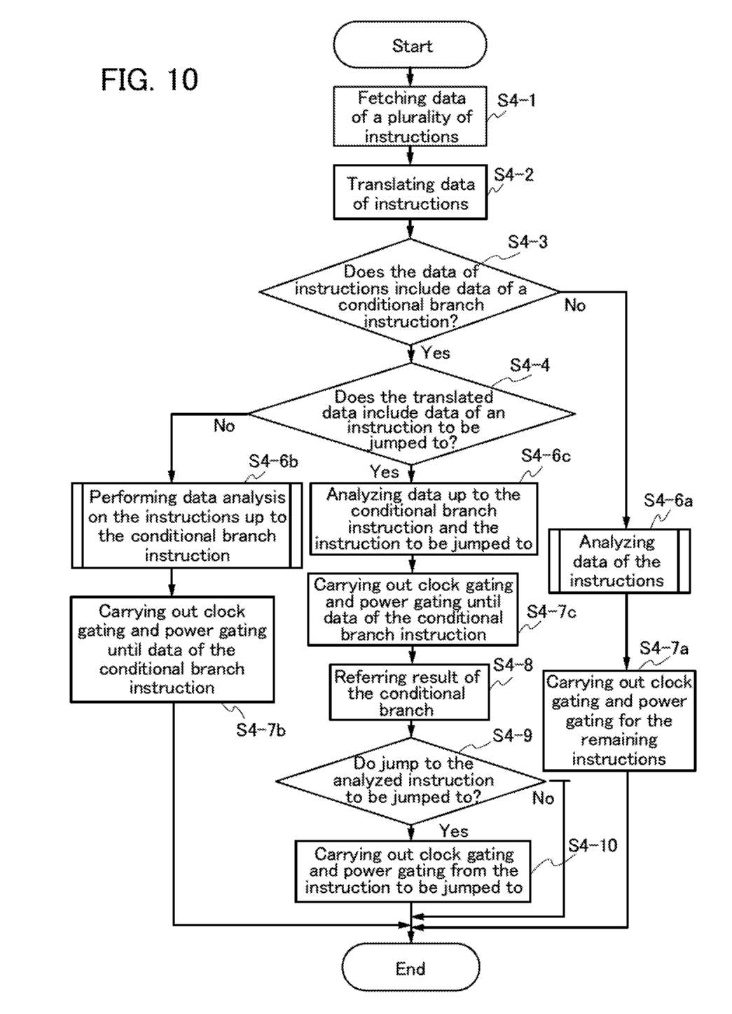

Still another example of the method for driving the processor of this embodiment will be described with reference to a flowchart of FIG. 10. Note that for the same part as that in the aforementioned methods for driving the processor, the aforementioned methods for driving the processor are referred to as appropriate. Here, an example of the method for driving the processor shown in FIG. 2 will be described as an example.

In the example of the method for driving the processor shown in FIG. 2, data of a plurality of instructions is fetched in step S4-1, and the data of instructions fetched in the instruction register unit 101 is translated in step S4-2.

The translated data of the instructions is input to the functional circuit 130 in the logic unit 103 and the data analysis unit 104.

Further, in step S4-3, it is determined whether the data of the instructions includes data of a conditional branch instruction.

In the case where the data of the instructions does not include the data of the conditional branch instruction, the translated data of the instructions is analyzed in step S4-6a.

Next, in step S4-7a, the supply of the clock signal CLK or both the clock signal CLK and the power source voltage PWR to the functional circuit 130 is controlled in accordance with control signals generated in the data analysis unit 104, whereby clock gating and power gating are carried out.

In the case where the data of the instructions includes the data of a conditional branch instruction, it is determined in step S4-4 whether the translated data of the instructions includes data of an instruction to be jumped to in the conditional branch instruction. Whether the data includes an instruction to be jumped to can be determined by a high-order bit of the data, for example.

For example, in the case of the configuration shown in FIG. 17, in the usage timing analyzer circuit 141, the content of data of instructions stored in the register 161 is determined by the logic circuit 164 with use of address data stored in the program counter 163, whereby the data of the conditional branch instruction and the data to be jumped to in the conditional branch instruction are determined.

In the case where the data of the instructions does not include the data of an instruction to be jumped to, in step S4-6b, data analysis is performed on the instructions up to the conditional branch instruction among the plurality of translated instructions. After that, in step S4-7b, the supply of the clock signal CLK or both the clock signal CLK and the power source voltage PWR to the functional circuit 130 is controlled in accordance with the control signals generated in the data analysis unit 104, whereby clock gating and power gating are carried out for the instructions up to the conditional branch instruction.

In the case where the data of the instructions includes the data of an instruction to be jumped to, in step S4-6c, data analysis is performed on the instructions up to the conditional branch instruction and the instruction to be jumped to among the plurality of translated instructions.

For example, in the case of the configuration shown in FIG. 17, in the usage timing analyzer circuit 141, data up to the conditional branch instruction, and data indicating whether the functional circuit 130 operates or not, which corresponds to the data to be jumped to in the conditional branch instruction, are output from the memory 162 by the logic circuit 164.

Next, in step S4-7c, the supply of the clock signal CLK or both the clock signal CLK and the power source voltage PWR to the functional circuit 130 is controlled in accordance with the control signals generated in the data analysis unit 104, whereby clock gating and power gating are carried out for the instructions up to the conditional branch instruction. Further, in step S4-8, the result of the conditional branch is referred to.

Then, whether to jump to the analyzed instruction to be jumped to is determined in step S4-9. For example, whether to jump can be determined by monitoring data of a processing result of the jump instruction, which is stored in the storage unit 106, by the data analysis unit 104.

In the case of jumping to the instruction to be jumped to, a determination signal indicating the determination result is input to the data analysis unit 104. Then, in step S4-10, the supply of the clock signal CLK or both the clock signal CLK and the power source voltage PWR to the functional circuit 130 is controlled in accordance with control signals generated in the data analysis unit 104, whereby clock gating and power gating are carried out for the instruction to be jumped to and the subsequent instructions. In the case of not jumping to the instruction to be jumped to, the processing is completed.

For example, in the case of the configuration shown in FIG. 17, data of a processing result of a conditional branch instruction, which is stored in the storage unit 106, is input to the counter control circuit 165. In the case of jumping to an address to be jumped to indicated by the conditional branch instruction, when the counter 166 has a count value corresponding to the data of the conditional branch instruction, the potential of the output node of the counter 166 is set to a count value corresponding to the data of the instruction to be jumped to by the counter control circuit 165. As a result, the data up to the conditional branch instruction and the data to be jumped can be output from the register 182 through the selector 183.

The functional circuit 130 supplied with the clock signal CLK and the power source voltage PWR operates in accordance with input data of instructions. The data of instructions is input to the functional circuit 130 through the data analysis unit 104; however, one embodiment of the present invention is not limited to this, and data of instructions translated in the instruction decoder unit 102 may be directly input to the logic unit 103.

If there is another data of instructions, the above operation is carried out again.

That is the description of another example of the method for driving the processor of this embodiment.

As described above, in another example of the method for driving the processor of this embodiment, processing is changed depending on whether there is a conditional branch instruction or not and whether there is data to be jumped to or not, which avoids unnecessary analysis of data of instructions and thus increases operation speed.

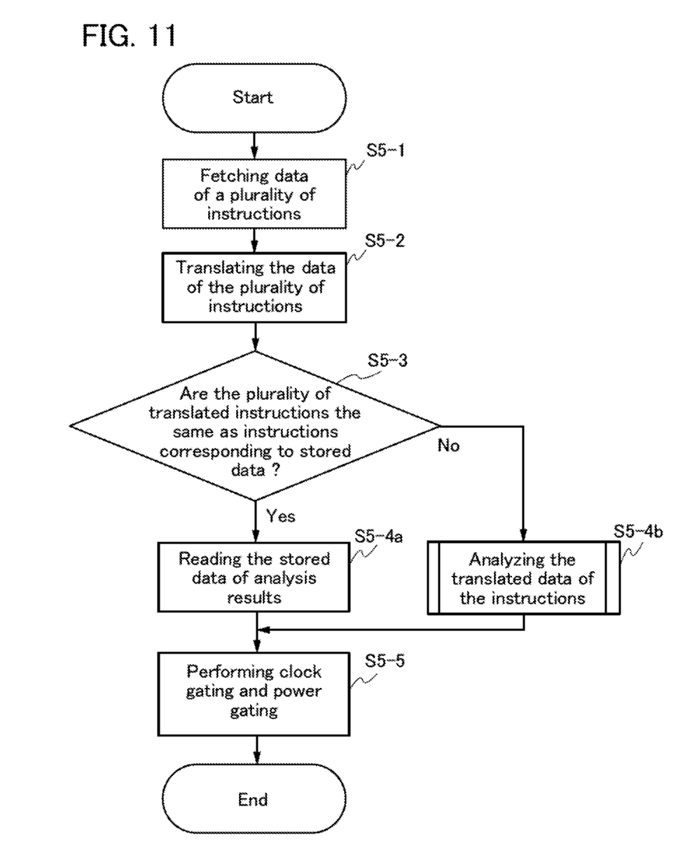

A still further example of the method for driving the processor of this embodiment will be described with reference to a flowchart of FIG. 11. Note that for the same part as that in the aforementioned methods for driving the processor, the aforementioned methods for driving the processor are referred to as appropriate. Here, an example of the method for driving the processor shown in FIG. 2 will be described as an example.

In the example of the method for driving the processor shown in FIG. 2, data of a plurality of instructions is fetched in step S5-1, and the data of instructions fetched in the instruction register unit 101 is translated in step S5-2.

The translated data of the instructions is input to the functional circuit 130 in the logic unit 103 and the data analysis unit 104.

Then, it is determined in step S5-3 whether the plurality of translated instructions are the same as instructions corresponding to data stored in the storage unit 106. In order to determine this, for example, the translated data and data indicating analysis results are stored in the storage unit 106 in advance, and the stored data of instructions is compared with the input data of instructions.

For example, in the case of the configuration shown in FIG. 17, in the usage timing analyzer circuit 141, the logic circuit 164 determines whether data of instructions stored in the register 161 is the same as data stored in the storage unit 106.

In the case where the plurality of translated instructions are the same as instructions corresponding to the data stored in the storage unit 106, the stored data of analysis results is read in step S5-4a. Then, in step S5-5, the supply of a clock signal or both a clock signal and a power source voltage to the functional circuit 130 is controlled in accordance with control signals generated in the data analysis unit 104, whereby clock gating and power gating are carried out.

In the case where the plurality of translated instructions are not the same as the instructions corresponding to the data stored in the storage unit 106, the plurality of translated instructions are analyzed in step S5-4b. After that, in step S5-5, the supply of the clock signal CLK or both the clock signal CLK and the power source voltage PWR to the functional circuit 130 is controlled in accordance with the control signals generated in the data analysis unit 104, whereby clock gating and power gating are carried out.

The functional circuit 130 supplied with the clock signal CLK and the power source voltage PWR operates in accordance with input data of instructions. The data of instructions is input to the functional circuit 130 through the data analysis unit 104; however, one embodiment of the present invention is not limited to this, and data of instructions translated in the instruction decoder unit 102 may be directly input to the logic unit 103.

That is the description of another example of the method for driving the processor of this embodiment.

As described above, in another example of the method for driving the processor of this embodiment, data analysis of the same instructions can be omitted because the analysis data of instructions is stored in the storage unit 106, resulting in an increase in operation speed.

As described with reference to FIG. 1 to FIG. 11, in an example of the processor of this embodiment, data of sequential instructions is translated (decoded) at a time and data of two or more instructions among the translated instructions is analyzed so as to calculate the length of a non-operating period of the functional circuit when the two or more instructions among the plurality of instructions are sequentially executed. In accordance with the analysis result, clock gating or both clock gating and power gating is performed on the functional circuit. Thus, power consumption can be reduced.

### Embodiment 2

Described in this embodiment is an example of a configuration of a register which can be used for the processor of one embodiment of the present invention.

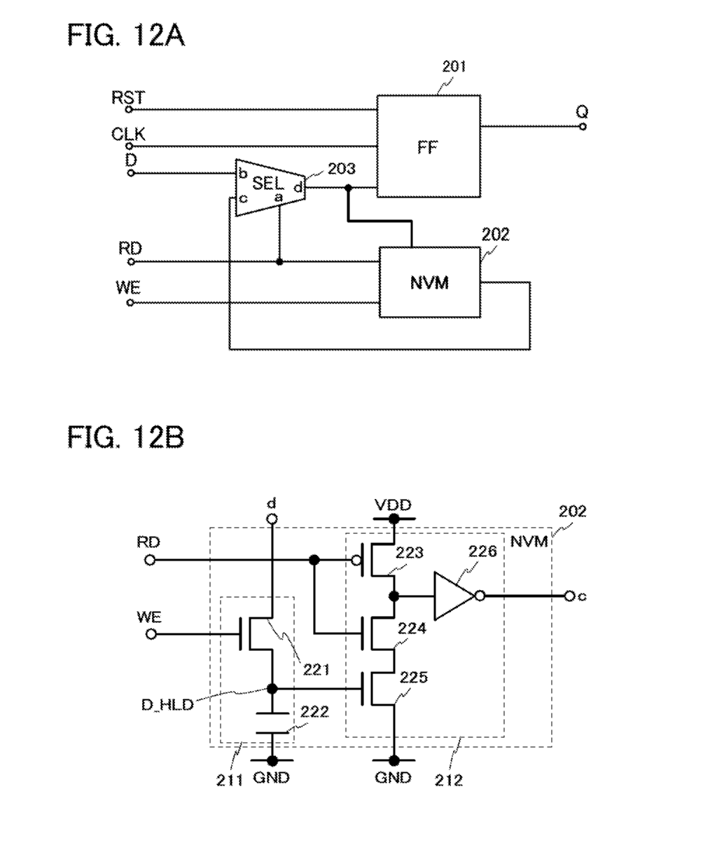

FIGS. 12A and 12B show an example of the configuration of the register of this embodiment.

The register shown in FIG. 12A includes a flip-flop (also referred to as FF) 201, a memory circuit (also referred to as NVM) 202, and a selector (also referred to as SEL) 203. Note that the flip-flop 201 and the memory circuit 202 may be considered as one memory circuit, and the register may include a plurality of memory circuits.

The flip-flop 201 is supplied with a reset signal RST, a clock signal CLK, and a data signal. The flip-flop 201 has a function of holding data of the data signal that is input in response to the clock signal CLK and outputting the data as a data signal Q.

The memory circuit 202 is supplied with a write control signal WE, a read control signal RD, and a data signal.

The memory circuit 202 has a function of storing data of an input data signal in accordance with the write control signal WE and outputting the stored data as a data signal in accordance with the read control signal RD.

The selector 203 is supplied with the read control signal RD through a terminal a, supplied with the data signal D through a terminal b, and supplied with a data signal (D_NVM) output from the memory circuit 202 through a terminal c.

The selector 203 has a function of selecting whether to output the data signal D or the data signal D_NVM through a terminal d, in accordance with the read control signal RD.

Next, an example of a configuration of the memory circuit 202 will be described with reference to FIG. 12B.

As shown in FIG. 12B, the memory circuit 202 includes a data holding unit 211 and a data reading unit 212. Note that without limitation to this, the memory circuit 202 may include a phase-change random access memory (PRAM), a resistive random access memory (ReRAM), a magnetic random access memory (MRAM), or the like. For the MRAM, a magnetic tunnel junction element (MTJ element) can be used for example.

The data holding unit 211 includes a transistor 221 and a capacitor 222.

The transistor 221 is an n-channel transistor. One of a source and a drain of the transistor 221 is electrically connected to the output terminal (terminal d) of the selector 203. The transistor 221 has a function of controlling holding of a data signal input from the selector 203, in accordance with the write control signal WE.

As the transistor 221, a transistor with low off-state current can be used.

In that case, it is preferable that the off-state current per micrometer of channel width of the transistor with low off-state current be lower than or equal to 1×10⁻¹⁹ A (100 zA) at room temperature (25° C.).

As the aforementioned transistor with low off-state current, a transistor using an oxide semiconductor for a channel formation region can be employed. A metal oxide-based material can be used for the oxide semiconductor, and examples of the oxide semiconductor are a metal oxide containing zinc and at least one of indium and gallium, and the metal oxide in which gallium is partly or entirely replaced with another metal element.

A structure of an oxide semiconductor film is described below.

An oxide semiconductor film is classified roughly into a single-crystal oxide semiconductor film and a non-single-crystal oxide semiconductor film. The non-single-crystal oxide semiconductor film includes any of an amorphous oxide semiconductor film, a microcrystalline oxide semiconductor film, a polycrystalline oxide semiconductor film, a c-axis aligned crystalline oxide semiconductor (CAAC-OS) film, and the like.

The amorphous oxide semiconductor film has disordered atomic arrangement and no crystalline component. A typical example thereof is an oxide semiconductor film in which no crystal part exists even in a microscopic region, and the whole of the film is amorphous.

The microcrystalline oxide semiconductor film includes a microcrystal (also referred to as nanocrystal) with a size greater than or equal to 1 nm and less than 10 nm, for example. Thus, the microcrystalline oxide semiconductor film has a higher degree of atomic order than the amorphous oxide semiconductor film. Hence, the density of defect states of the microcrystalline oxide semiconductor film is lower than that of the amorphous oxide semiconductor film.

The CAAC-OS film is one of oxide semiconductor films including a plurality of crystal parts, and most of each crystal part fits inside a cube whose one side is less than 100 nm. Thus, there is a case where a crystal part included in the CAAC-OS film fits a cube whose one side is less than 10 nm, less than 5 nm, or less than 3 nm. The density of defect states of the CAAC-OS film is lower than that of the microcrystalline oxide semiconductor film. The CAAC-OS film is described in detail below.

In this specification, a term “parallel” indicates that the angle formed between two straight lines is greater than or equal to −10° and less than or equal to 10°, and accordingly also includes the case where the angle is greater than or equal to −5° and less than or equal to 5°. In addition, a term “perpendicular” indicates that the angle formed between two straight lines is greater than or equal to 80° and less than or equal to 100°, and accordingly includes the case where the angle is greater than or equal to 85° and less than or equal to 95°.

In this specification, the trigonal and rhombohedral crystal systems are included in the hexagonal crystal system.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in a direction substantially parallel to a sample surface (cross-sectional TEM image), metal atoms are arranged in a layered manner in the crystal parts. Each metal atom layer has a morphology reflected by a surface over which the CAAC-OS film is formed (hereinafter, a surface over which the CAAC-OS film is formed is referred to as a formation surface) or a top surface of the CAAC-OS film, and is arranged in parallel to the formation surface or the top surface of the CAAC-OS film.

On the other hand, according to the TEM image of the CAAC-film observed in a direction substantially perpendicular to the sample surface (plan TEM image), metal atoms are arranged in a triangular or hexagonal configuration in the crystal parts. However, there is no regularity of arrangement of metal atoms between different crystal parts.

From the results of the cross-sectional TEM image and the plan TEM image, alignment is found in the crystal parts in the CAAC-OS film.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned in a direction parallel to a normal vector of a formation surface or a normal vector of a top surface. Thus, for example, in the case where a shape of the CAAC-OS film is changed by etching or the like, the c-axis might not be necessarily parallel to a normal vector of a formation surface or a normal vector of a top surface of the CAAC-OS film.

Further, the degree of crystallinity in the CAAC-OS film is not necessarily uniform. For example, in the case where crystal growth leading to the CAAC-OS film occurs from the vicinity of the top surface of the film, the degree of the crystallinity in the vicinity of the top surface is higher than that in the vicinity of the formation surface in some cases. Further, when an impurity is added to the CAAC-OS film, the crystallinity in a region to which the impurity is added is changed, and the degree of crystallinity in the CAAC-OS film varies depends on regions.

Note that when the CAAC-OS film with an InGaZnO₄ crystal is analyzed by an out-plane method, a peak of 2θ may also be observed at around 36°, in addition to the peak of 2θ at around 31°. The peak of 2θ at around 36° is derived from the (311) plane of a ZnGa₂O₄ crystal; such a peak indicates that a ZnGa₂O₄ crystal is included in part of the CAAC-OS film including the InGaZnO₄ crystal. It is preferable that in the CAAC-OS film, a peak of 2θ appears at around 31° and a peak of 2θ does not appear at around 36°.

In a transistor using the CAAC-OS film, change in electric characteristics due to irradiation with visible light or ultraviolet light is small. Thus, the transistor has high reliability.

Note that an oxide semiconductor film may be a stacked film including two or more films of an amorphous oxide semiconductor film, a microcrystalline oxide semiconductor film, and a CAAC-OS film, for example.

The carrier density of the oxide semiconductor including the channel is lower than 1×10¹⁴ atoms/cm³, preferably lower than 1×10¹² atoms/cm³, and more preferably lower than 1×10¹¹ atoms/cm³. In order to realize such a carrier density, the concentration of donor impurities contained in the oxide semiconductor needs to be reduced: for example, the amount of hydrogen regarded as a donor impurity is preferably reduced to 1×10¹⁹ atoms/cm³ or lower, more preferably 1×10¹⁸ atoms/cm³ or lower.

With the above carrier density, the off-state current per micrometer of channel width of a field-effect transistor can be reduced to 1×10⁻¹⁹ A (100 zA) or lower, preferably 1×10⁻²⁰ A (10 zA) or lower, more preferably 1×10⁻²¹ A (1 zA) or lower, and even more preferably 1×10⁻²² A (100 yA) or lower.

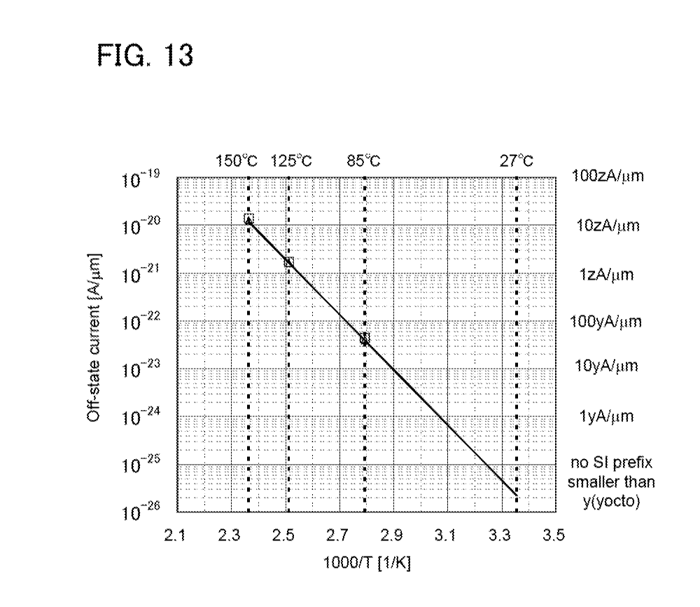

The off-state current of a transistor will be described with reference to FIG. 13, the transistor including a channel formation region using an oxide semiconductor containing indium, zinc, and gallium.

Since the off-state current of the transistor is extremely low, in order to measure the off-state current, it is necessary to fabricate a transistor with a relatively large size and estimate an actually flowing off-state current.

As an example, FIG. 13 shows an Arrhenius plot of the off-state current estimated from the off-state current per micrometer of channel width W of a transistor having a channel width W of 1 m (1000000 μm) and a channel length L of 3 μm when the temperature changes to 150° C., 125° C., 85° C., and 27° C.

In FIG. 13, for example, the off-state current of the transistor at 27° C. is lower than or equal to 1×10⁻²⁵ A. FIG. 13 shows that the transistor including a channel formation region using an oxide semiconductor containing indium, zinc, and gallium has an extremely low off-state current.

By using the above transistor with low off-state current as the transistor 221, data can be held in the capacitor 222 even when the supply of a power source voltage is stopped.

Note that the transistor 221 may be stacked, for example, over a transistor (e.g., a transistor 223 and a transistor 224) included in a logic circuit, so that the circuit area can be reduced.

The transistor 221 may include a back-gate. The transistor 221 with a back-gate allows the threshold voltage of the transistor 221 to be shifted.

One of a pair of electrodes of the capacitor 222 is electrically connected to the other of the source and the drain of the transistor 221, and the other thereof is supplied with a ground potential. The capacitor 222 has a function of holding charge based on data (D_HLD) of a data signal to be stored. Since the off-state current of the transistor 221 is extremely low, the charge in the capacitor 222 is held and thus the data (D_HLD) is held even when the supply of a power source voltage PWR is stopped.

The data reading unit 212 includes the transistor 223, the transistor 224, a transistor 225, and an inverter 226.

The transistor 223 is a p-channel transistor. One of a source and a drain of the transistor 223 is supplied with a power source potential, and a gate of the transistor 223 is supplied with the read control signal RD. The difference between the power source potential and the ground potential is a power source voltage.

The transistor 224 is an n-channel transistor. One of a source and a drain of the transistor 224 is electrically connected to the other of the source and the drain of the transistor 223, and a gate of the transistor 224 is supplied with the read control signal RD.

The transistor 225 is an n-channel transistor. One of a source and a drain of the transistor 225 is electrically connected to the other of the source and the drain of the transistor 224, and the other thereof is supplied with the ground potential. The potential of a gate of the transistor 225 is the data D_HLD.

An input terminal of the inverter 226 is electrically connected to the other of the source and the drain of the transistor 223. An output terminal of the inverter 226 is electrically connected to the input terminal (terminal c) of the selector 203. An output signal of the inverter 226 is the data signal D_NVM.

As the transistors 223 to 225 and the inverter 226, for example, a transistor using silicon in a channel formation layer can be used.

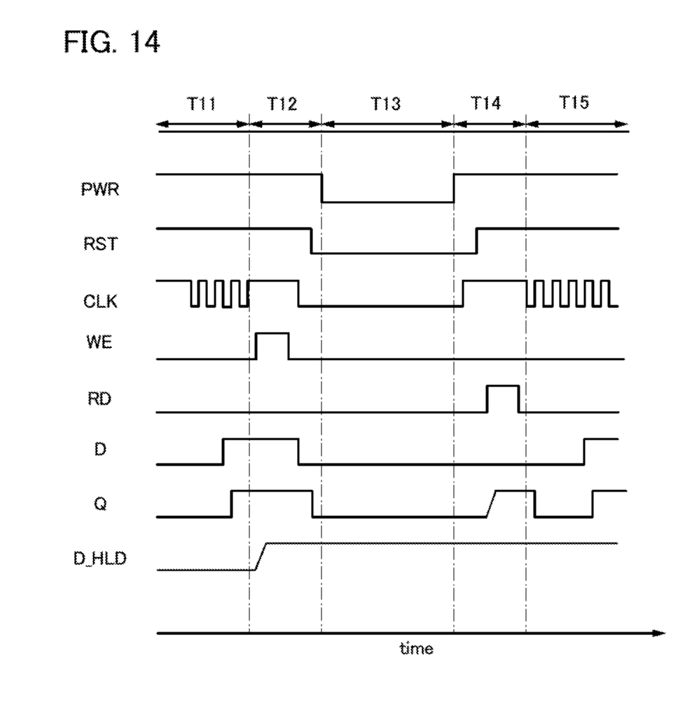

Next, an example of a method for driving the memory circuit shown in FIG. 12A will be described with reference to a timing chart of FIG. 14.

First, in a period T11 which is a normal operation period, the memory circuit is supplied with the power source voltage PWR, the reset signal RST, and the clock signal CLK. At this time, the selector 203 outputs data of the data signal D to the flip-flop 201. The flip-flop 201 holds the data of the data signal D that is input in accordance with the clock signal CLK.

Then, in a period T12 which is a backup period provided immediately before the supply of the power source voltage PWR is stopped, the data of the data signal D is stored in the memory circuit 202 in accordance with a pulse of the write control signal WE, and held as the data D_HLD in the memory circuit 202. After that, the supply of the clock signal CLK to the memory circuit is stopped, and then, the supply of the reset signal RST to the memory circuit is stopped.

Next, in a period T13 which is a power stop period, the supply of the power source voltage PWR to the memory circuit is stopped. During this period, the value of the data D_HLD is held in the memory circuit 202 because the off-state current of the transistor 221 is low. Note that the supply of the power source voltage PWR may be stopped by supplying the ground potential GND instead of the potential Vdd.

Then, in a period T14 which is a recovery period immediately before a normal operation period, the supply of the power source voltage PWR to the memory circuit is restarted; then, the supply of the clock signal CLK is restarted, and after that, the supply of the reset signal RST is restarted. At this time, before the supply of the clock signal CLK is restarted, the wiring supplied with the clock signal CLK is set to the potential Vdd. Moreover, the data signal D_NVM having a value corresponding to the data D_HLD is output to the selector 203 from the data reading unit 212 of the memory circuit 202 in accordance with a pulse of the read control signal RD. The selector 203 outputs the data signal D_NVM to the flip-flop 201 in accordance with the pulse of the read control signal RD. Thus, the flip-flop 201 can be returned to a state just before the power stop period.

Then, in a period T15 which is a normal operation period, normal operation of the flip-flop 201 is performed again.

That is an example of the method for driving the memory circuit.

When the register with the structure shown in FIGS. 12A and 12B is used for the functional circuit 130, data is saved in a second memory circuit immediately before the power supply is stopped, and then the data is input to a first memory circuit when the power supply is restarted; thus, a state just before the power supply is stopped can be recovered. In such a manner, the first memory circuit can be recovered quickly after restart of power supply.

### Embodiment 3

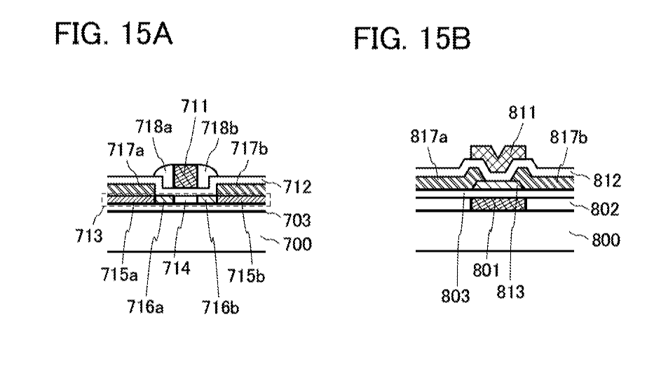

In this embodiment, examples of a structure of a transistor which can be used in one embodiment of the present invention will be described with reference to schematic cross-sectional views of FIGS. 15A and 15B. Note that components shown in FIGS. 15A and 15B are not to scale in some cases.

A transistor shown in FIG. 15A includes a conductive layer 711, an insulating layer 712, a semiconductor layer 713, conductive layers 717a and 717b, and insulating layers 718a and 718b.

The semiconductor layer 713 is provided over an element formation layer 700 with an insulating layer 703 interposed therebetween. Note that the semiconductor layer 713 is not necessarily provided over the insulating layer 703 and may be provided directly on the element formation layer 700.

In the semiconductor layer 713, a region 715a and a region 715b to which a dopant is added are provided separately from each other. Moreover, in the semiconductor layer 713, a region 716a and a region 716b to which a dopant is added at a lower concentration than that in the regions 715a and 715b are provided between the regions 715a and 715b. The regions 716a and 716b make it possible to suppress electric-field concentration in the transistor. The semiconductor layer 713 also includes a channel formation region 714 between the regions 716a and 716b.

The conductive layer 717a is electrically connected to the region 715a in the semiconductor layer 713, and the conductive layer 717b is electrically connected to the region 715b in the semiconductor layer 713.

The insulating layer 712 is provided over the semiconductor layer 713.

The conductive layer 711 overlaps with the semiconductor layer 713 with the insulating layer 712 interposed therebetween.

The insulating layer 718a is in contact with one of a pair of side surfaces of the conductive layer 711, and the insulating layer 718b is in contact with the other side surface.

A transistor shown in FIG. 15B includes a conductive layer 801, an insulating layer 802, an insulating layer 803, a conductive layer 811, an insulating layer 812, a semiconductor layer 813, and conductive layers 817a and 817b.

The conductive layer 801 is provided over an element formation layer 800.

The insulating layer 802 is provided over the element formation layer 800.

The conductive layer 801 and the insulating layer 802 are formed by, for example, planarization treatment (e.g., CMP treatment) performed on a stack of a conductive film and an insulating layer.

The insulating layer 803 is provided over the conductive layer 801 and the insulating layer 802.

The semiconductor layer 813 overlaps with the conductive layer 801 with the insulating layer 803 interposed therebetween.

The conductive layers 817a and 817b are electrically connected to the semiconductor layer 813.

The insulating layer 812 is provided over the semiconductor layer 813 and the conductive layers 817a and 817b.

The components will be further described below. Each of the components is not necessarily a single layer, and may be a stack of layers.

The insulating layer 703 is a base layer. The insulating layer 703 can be, for example, a layer containing a material such as silicon oxide, silicon nitride, silicon oxynitride, silicon nitride oxide, aluminum oxide, aluminum nitride, aluminum oxynitride, aluminum nitride oxide, or hafnium oxide.

The insulating layer 802 can be made of any of the materials that can be used for the insulating layer 703.

The semiconductor layers 713 and 813 each function as a layer in which a channel of the transistor is formed (also referred to as a channel formation layer).

The semiconductor layers 713 and 813 can be formed using, for example, the oxide semiconductor layer that can be used for the transistor 221 shown in the above embodiment 2.

As the dopants contained in the regions 715a and 715b and the regions 716a and 716b, it is possible to use an element of Group 13 in the periodic table (e.g., boron), an element of Group 15 in the periodic table (e.g., one or more of nitrogen, phosphorus, and arsenic), and/or a rare gas element (e.g., one or more of helium, argon, and xenon), for example. At least one of these elements can be used as the dopants.

The insulating layers 712, 803, and 812 each function as a gate insulating layer of the transistor. The insulating layers 712, 803, and 812 can be, for example, a layer containing a material such as silicon oxide, silicon nitride, silicon oxynitride, silicon nitride oxide, aluminum oxide, aluminum nitride, aluminum oxynitride, aluminum nitride oxide, or hafnium oxide.

The conductive layers 711 and 811 each function as a gate of the transistor. The conductive layers 711 and 811 can be, for example, a layer containing a metal material such as molybdenum, titanium, chromium, tantalum, magnesium, silver, tungsten, aluminum, copper, neodymium, or scandium.

The conductive layer 801 functions as a back-gate of the transistor. Although the conductive layer 801 is not necessarily provided, the conductive layer 801 makes it possible to control the threshold voltage of the transistor. The conductive layer 801 can be made of, for example, any of the materials that can be used for the conductive layers 711 and 811.

The insulating layers 718a and 718b can be, for example, a layer containing a material such as silicon oxide, silicon nitride, silicon oxynitride, silicon nitride oxide, aluminum oxide, aluminum nitride, aluminum oxynitride, aluminum nitride oxide, or hafnium oxide.

The conductive layers 717a and 717b and the conductive layers 817a and 817b each function as a source or a drain of the transistor. The conductive layers 717a and 717b and the conductive layers 817a and 817b can be, for example, a layer containing a metal material such as molybdenum, titanium, chromium, tantalum, magnesium, silver, tungsten, aluminum, copper, neodymium, scandium, or ruthenium.

The transistors shown in FIGS. 15A and 15B can be used for the transistor 221 in the above embodiment 2, for example.

That is the description of examples of the structure of the transistor shown in FIGS. 15A and 15B.

As described with reference to FIGS. 15A and 15B, in the examples of the transistor of this embodiment, an oxide semiconductor layer is used for the transistor which controls data writing and reading. With such a structure, data can be held for a long time.

In addition, the transistor shown as an example in this embodiment may be stacked over a transistor including a semiconductor layer such as a silicon layer, which allows a reduction in circuit area.

### Embodiment 4

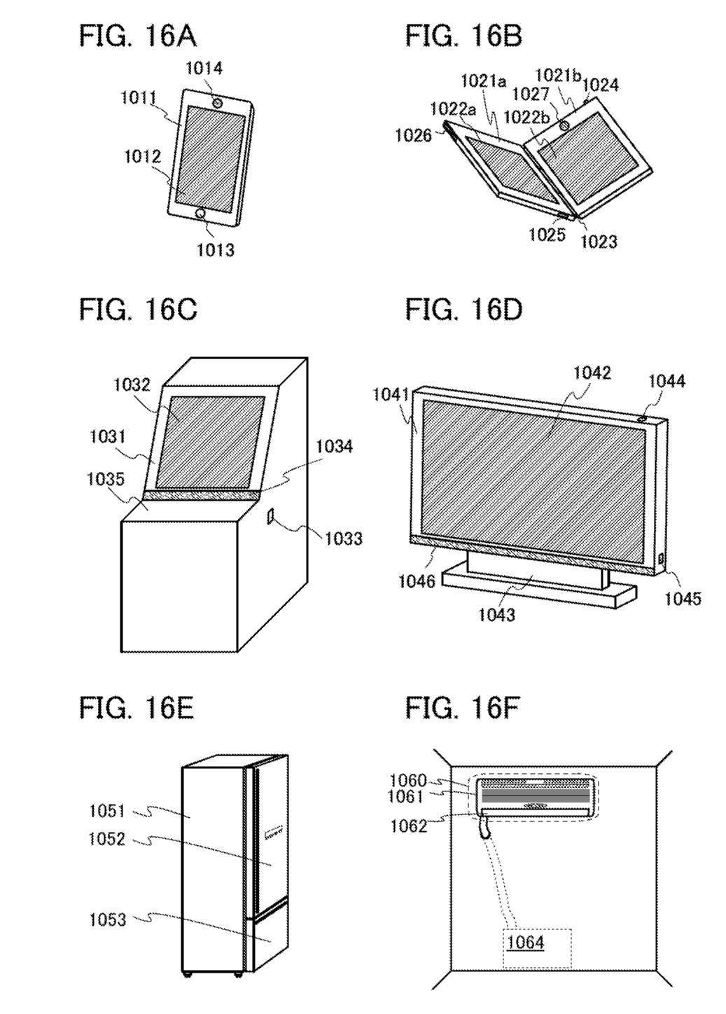

In this embodiment, examples of electronic devices including a processor which is one embodiment of the present invention will be described with reference to FIGS. 16A to 16F.

The electronic device shown in FIG. 16A is an example of a portable information terminal.

The electronic device shown in FIG. 16A includes a housing 1011, a panel 1012 incorporated in the housing 1011, a button 1013, and a speaker 1014.

The housing 1011 may be provided with a connection terminal for connecting the electronic device to an external device and a button for operating the electronic device.

The panel 1012 is a display panel (display). The panel 1012 preferably has a function of a touch panel.

The button 1013 is provided on the housing 1011. When the button 1013 is a power button, for example, the electronic device can be turned on or off by pressing the button 1013.

The speaker 1014 is provided on the housing 1011. The speaker 1014 outputs sound.

The housing 1011 may be provided with a microphone, in which case the electronic device in FIG. 16A can function as a telephone, for example.

In the electronic device in FIG. 16A, the processor which is one embodiment of the present invention is provided inside the housing 1011.

The electronic device shown in FIG. 16A functions as, for example, one or more of a telephone set, an e-book reader, a personal computer, and a game machine.

The electronic device shown in FIG. 16B is an example of a foldable information terminal.

The electronic device shown in FIG. 16B includes a housing 1021a, a housing 1021b, a panel 1022a incorporated in the housing 1021a, a panel 1022b incorporated in the housing 1021b, a hinge 1023, a button 1024, a connection terminal 1025, a storage medium insertion portion 1026, and a speaker 1027.

The housing 1021a and the housing 1021b are connected to each other by the hinge 1023.

The panels 1022a and 1022b are display panels (displays). The panels 1022a and 1022b preferably have a function of a touch panel.

Since the electronic device in FIG. 16B includes the hinge 1023, it can be folded so that the panels 1022a and 1022b face each other.

The button 1024 is provided on the housing 1021b. Note that the button 1024 may be provided on the housing 1021a. For example, when the button 1024 which functions as a power button is provided and pushed, the supply of a power voltage to the electronic device can be controlled.

The connection terminal 1025 is provided on the housing 1021a. Note that the connection terminal 1025 may be provided on the housing 1021b. Alternatively, a plurality of the connection terminals 1025 may be provided on one or both of the housings 1021a and 1021b. The connection terminal 1025 is a terminal for connecting the electronic device in FIG. 16B to another device.

The storage medium inserting portion 1026 is provided on the housing 1021a. The storage medium insertion portion 1026 may be provided on the housing 1021b. Alternatively, a plurality of the storage medium insertion portions 1026 may be provided on one or both of the housings 1021a and 1021b. For example, when a card-type recording medium is inserted into the recording medium insertion portion, data can be read to the electronic device from the card-type recording medium or data stored in the electronic device can be written to the card-type recording medium.

The speaker 1027 is provided on the housing 1021b. The speaker 1027 outputs sound. Note that the speaker 1027 may be provided on the housing 1021a.

The housing 1021a or the housing 1021b may be provided with a microphone, in which case the electronic device in FIG. 16B can function as a telephone, for example.

In the electronic device in FIG. 16B, the processor which is one embodiment of the present invention is provided inside the housing 1021a or the housing 1021b.

The electronic device shown in FIG. 16B functions as, for example, one or more of a telephone set, an e-book reader, a personal computer, and a game machine.

The electronic device shown in FIG. 16C is an example of a stationary information terminal. The stationary information terminal shown in FIG. 16C includes a housing 1031, a panel 1032 incorporated in the housing 1031, a button 1033, and a speaker 1034.

The panel 1032 is a display panel (display). The panel 1032 preferably has a function of a touch panel.

Note that a panel similar to the panel 1032 may be provided on a deck portion 1035 of the housing 1031. This panel preferably has a function of a touch panel.

The housing 1031 may be provided with one or more of a ticket slot from which a ticket or the like is dispensed, a coin slot, and a bill slot.

The button 1033 is provided on the housing 1031. For example, when the button 1033 is a power button, the supply of a power voltage to the electronic device can be controlled by pressing the button 1033.

The speaker 1034 is provided on the housing 1031. The speaker 1034 outputs sound.

In the electronic device in FIG. 16C, the processor which is one embodiment of the present invention is provided inside the housing 1031.

The electronic device shown in FIG. 16C functions as, for example, an automated teller machine, an information communication terminal for ordering a ticket or the like (also referred to as a multi-media station), or a game machine.

FIG. 16D shows an example of a stationary information terminal. The electronic device shown in FIG. 16D includes a housing 1041, a panel 1042 incorporated in the housing 1041, a support 1043 supporting the housing 1041, a button 1044, a connection terminal 1045, and a speaker 1046.

Note that the housing 1041 may be provided with a connection terminal for connecting the electronic device to an external device

The panel 1042 functions as a display panel (display).

The button 1044 is provided on the housing 1041. For example, when the button 1044 is a power button, the supply of a power voltage to the electronic device can be controlled by pressing the button 1044.

The connection terminal 1045 is provided on the housing 1041. The connection terminal 1045 is a terminal for connecting the electronic device in FIG. 16D to another device. For example, when the electronic device in FIG. 16D is connected to a personal computer with the connection terminal 1045, an image corresponding to a data signal input from the personal computer can be displayed on the panel 1042. For example, when the panel 1042 of the electronic device in FIG. 16D is larger than a panel of another electronic device connected thereto, a displayed image of the other electronic device can be enlarged, so that a plurality of viewers can easily see the image at the same time.

The speaker 1046 is provided on the housing 1041. The speaker 1046 outputs sound.

In the electronic device in FIG. 16D, the processor which is one embodiment of the present invention is provided inside the housing 1041.

The electronic device shown in FIG. 16D functions as, for example, one or more of an output monitor, a personal computer, and a television set.

FIG. 16E shows an example of an electric refrigerator-freezer. The electronic device shown in FIG. 16E includes a housing 1051, a refrigerator door 1052, and a freezer door 1053.

In the electronic device in FIG. 16E, the processor which is one embodiment of the present invention is provided inside the housing 1051. With this structure, the supply of a power voltage to the processor in the housing 1051 can be controlled in response to opening and closing of the refrigerator door 1052 and the freezer door 1053, for example.

FIG. 16F shows an example of an air conditioner. The electronic device shown in FIG. 16F includes an indoor unit 1060 and an outdoor unit 1064.

The indoor unit 1060 includes a housing 1061 and a ventilation duct 1062.

In the electronic device in FIG. 16F, the processor which is one embodiment of the present invention is provided inside the housing 1061. With this structure, the supply of a power voltage to the processor in the housing 1061 can be controlled in response to a signal from a remote controller, for example.

Note that the split-type air conditioner including the indoor unit and the outdoor unit is shown in FIG. 16F as an example; alternatively, an air conditioner may be such that the functions of an indoor unit and an outdoor unit are integrated in one housing.

The processor which is one embodiment of the present invention can also be used for a high-frequency heating apparatus such as a microwave oven, an electric rice cooker, and the like, without limitation to the above.

That is the description of examples of the electronic devices shown in FIGS. 16A to 16F.

As described with reference to FIGS. 16A to 16F, a reduction in the power consumption of the electronic devices of this embodiment can be achieved by using the processor which is one embodiment of the present invention.

### EXPLANATION OF REFERENCE

100: data of instructions 101: instruction register unit 102: instruction decoder unit 103: logic unit 104: data analysis unit 105: control unit 106: storage unit 111: instruction register 130: functional circuit 141: usage timing analyzer circuit 142: stopping timing analyzer circuit 143: control signal output circuit 151: clock signal control circuit 152: power source voltage control circuit 161: register 162: memory 163: program counter 164: logic circuit 165: counter control circuit 166: counter 171: shift register 172: logic circuit 181: shift register 182: register 183: selector 201: flip-flop 202: memory circuit 203: selector 211: data holding unit 212: data reading unit 221: transistor 222: capacitor 223: transistor 224: transistor 225: transistor 226: inverter 1011: housing 1012: panel 1013: button 1014: speaker 1021a: housing 1021b: housing 1022a: panel 1022b: panel 1023: hinge 1024: button 1025: connection terminal 1026: storage medium insertion portion 1027: speaker 1031: housing 1032: panel 1033: button 1034: speaker 1035: deck portion 1041: housing 1042: panel 1043: support 1044: button 1045: connection terminal 1046: speaker 1051: housing 1052: refrigerator door 1053: freezer door 1060: indoor unit 1061: housing 1062: ventilation duct 1064: outdoor unit

This application is based on Japanese Patent Application serial No. 2012-075775 filed with Japan Patent Office on Mar. 29, 2012, the entire contents of which are hereby incorporated by reference.

1. A processor comprising:
an instruction register unit fetching data including a plurality of instructions;
an instruction decoder unit translating the data including the plurality of instructions fetched in the instruction register unit;
a functional circuit being supplied with a clock signal, a power source voltage and a data signal which includes translated data including the plurality of instructions, and operating in accordance with the translated data of the plurality of instructions;
a data analysis unit analyzing data translated by the instruction decoder unit including two or more instructions among the plurality of instructions so as to calculate a non-operating period of the functional circuit when the two or more instructions are sequentially executed, and generating a control signal so as to stop supply of the clock signal or both the clock signal and the power source voltage to the functional circuit in accordance with a length of the non-operating period; and
a control unit controlling the supply of the clock signal or both the clock signal and the power source voltage to the functional circuit in accordance with the control signal.

2. The processor according to claim 1,
wherein in the data analysis unit, the control signal is set to a value which allows the supply of the clock signal to the functional circuit to be stopped when the non-operating period is longer than a first period, and the control signal is set to a value which allows the supply of the clock signal and the power source voltage to the functional circuit to be stopped when the non-operating period is longer than a second period.

3. The processor according to claim 1,
wherein the functional circuit comprises a register,
wherein the register comprises:
a first memory circuit in which data is held in a period during which the power source voltage is supplied to the functional circuit; and
a second memory circuit in which data is held in a period during which the supply of the power source voltage to the functional circuit is stopped,
wherein the second memory circuit comprises a field-effect transistor which controls data writing and holding, and
wherein an off-state current per micrometer of channel width of the field-effect transistor is lower than or equal to 100 zA.

4. The processor according to claim 3,
wherein the field-effect transistor comprises an oxide semiconductor.

5. An electronic device comprising the processor according to claim 1.

6. A processor comprising:
an instruction register unit fetching data including a plurality of instructions;
an instruction decoder unit translating the data including the plurality of instructions fetched in the instruction register unit;
a functional circuit being supplied with a clock signal, a power source voltage and a data signal which includes translated data including the plurality of instructions, and operating in accordance with the translated data of the plurality of instructions;
a data analysis unit determining whether data translated by the instruction decoder unit including the plurality of instructions includes data of a conditional branch instruction, analyzing data translated by the instruction decoder unit, including two or more instructions so as to calculate a non-operating period of the functional circuit when the two or more instructions are sequentially executed, and generating a control signal so as to stop supply of the clock signal or both the clock signal and the power source voltage to the functional circuit in accordance with a length of the non-operating period in the case where the data translated by the instruction decoder unit including the plurality of instructions includes the data of the conditional branch instruction; and
a control unit controlling the supply of the clock signal or both the clock signal and the power source voltage to the functional circuit in accordance with the control signal,
wherein the two or more instructions are instructions to be operated by the functional circuit before the conditional branch instruction.

7. The processor according to claim 6,
wherein in the data analysis unit, the control signal is set to a value which allows the supply of the clock signal to the functional circuit to be stopped when the non-operating period is longer than a first period, and the control signal is set to a value which allows the supply of the clock signal and the power source voltage to the functional circuit to be stopped when the non-operating period is longer than a second period.

8. The processor according to claim 6,
wherein the functional circuit comprises a register,
wherein the register comprises:
a first memory circuit in which data is held in a period during which the power source voltage is supplied to the functional circuit; and
a second memory circuit in which data is held in a period during which the supply of the power source voltage to the functional circuit is stopped,
wherein the second memory circuit comprises a field-effect transistor which controls data writing and holding, and
wherein an off-state current per micrometer of channel width of the field-effect transistor is lower than or equal to 100 zA.

9. The processor according to claim 8,
wherein the field-effect transistor comprises an oxide semiconductor.

10. An electronic device comprising the processor according to claim 6.

11. A driving method of a processor comprising the steps of:
fetching data including a plurality of instructions;
translating the data including the plurality of instructions;
supplying a functional circuit with a clock signal, a power source voltage and a data signal which includes translated data including the plurality of instructions so that the functional circuit operates in accordance with the translated data including the plurality of instructions;
analyzing translated data including two or more instructions among the plurality of instructions so as to calculate a non-operating period of the functional circuit when the two or more instructions are sequentially executed, and generating a control signal so as to stop supply of the clock signal or both the clock signal and the power source voltage to the functional circuit in accordance with a length of the non-operating period; and
controlling the supply of the clock signal or both the clock signal and the power source voltage to the functional circuit in accordance with the control signal.

12. The driving method of a processor according to claim 11, further comprising the step of:
setting the control signal to a value which allows the supply of the clock signal to the functional circuit to be stopped when the non-operating period is longer than a first period, and setting the control signal to a value which allows the supply of the clock signal and the power source voltage to the functional circuit to be stopped when the non-operating period is longer than a second period.
